(19) United States
(12) Patent Application Publication
(10) Pub. No.: US 2003/0111501 A1
(43) Pub. Date: Jun. 19, 2003

(54) ATV load support system

(76) Inventors: Thomas V. McGraw, Buffalo Lake, MN (US); Bruce Speer, Lake Park, MN (US)

Correspondence Address: Michael S. Neustel, Suite No. 4, 2534 South University Drive, Fargo, ND, 58103, US

(21) Appl. No.: 10/026,136

(22) Filed: Dec. 18, 2001

(51) Int. Cl. B60R 7/00; B60R 9/00

(52) U.S. Cl. 224/410

(57) ABSTRACT

An ATV load support system for assisting in the supporting of a load positioned upon an ATV. The ATV load support system includes an elongate support member pivotally attached to a frame of the ATV extending rearwardly, an upper frame attached to the elongate support member for receiving a load, a vertical member attached to the upper frame extending downwardly, an attachment member having an upper bracket attached to a rear hitch of an ATV, and a first shock absorber and compression spring attached between the upper bracket and the vertical member. The weight of the load is transferred from the rear suspension of the ATV directly to the rear axle of the ATV thereby reducing wear upon the rear suspension.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to all terrain vehicles (ATV) and more specifically it relates to an ATV load support system for assisting in the supporting of a load positioned upon an ATV.

2. Description of the Prior Art

ATV load support devices have been in use for years. Conventional ATV load support devices are typically comprised of a support frame directly attached to the rear rack or frame of the ATV for supporting a load. The load may be comprised of various items such as but not limited to chemical sprayers and applicators, electric generators, weight members and similar devices. The weight of the load is directly supported by the rear suspension of the ATV.

The main problem with conventional ATV load support devices is that the rear suspension of the ATV incurs relatively significant wear when the load is positioned upon the support devices. The weight of the load is directly supported by the shock absorbers and springs of the rear suspension which decreases the useful life of the rear suspension components. A further problem with conventional ATV load support devices is that they provide a rougher ride for the operator of the ATV as the weight of the load in addition to the operator is supported by the rear suspension thereby compressing the rear suspension.

While these devices may be suitable for the particular purpose to which they address, they are not as suitable for assisting in the supporting of a load positioned upon an ATV. Conventional ATV load support devices are not designed for transferring the weight of a load from the rear suspension to the rear axle.

In these respects, the ATV load support system according to the present invention substantially departs from the conventional concepts and designs of the prior art, and in so doing provides an apparatus primarily developed for the purpose of assisting in the supporting of a load positioned upon an ATV.

### SUMMARY OF THE INVENTION

In view of the foregoing disadvantages inherent in the known types of ATV support devices now present in the prior art, the present invention provides a new ATV load support system construction wherein the same can be utilized for assisting in the supporting of a load positioned upon an ATV.

The general purpose of the present invention, which will be described subsequently in greater detail, is to provide a new ATV load support system that has many of the advantages of the ATV load support devices mentioned heretofore and many novel features that result in a new ATV load support system which is not anticipated, rendered obvious, suggested, or even implied by any of the prior art ATV load support devices, either alone or in any combination thereof.

To attain this, the present invention generally comprises an elongate support member pivotally attached to a frame of the ATV extending rearwardly, an upper frame attached to the elongate support member for receiving a load, a vertical member attached to the upper frame extending downwardly, an attachment member having an upper bracket attached to a rear hitch of an ATV, and a first shock absorber and compression spring attached between the upper bracket and the vertical member. The weight of the load is transferred from the rear suspension of the ATV directly to the rear axle of the ATV thereby reducing wear upon the rear suspension.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an ATV load support system that will overcome the shortcomings of the prior art devices.

A second object is to provide an ATV load support system for assisting in the supporting of a load positioned upon an ATV.

Another object is to provide an ATV load support system that increases the handling characteristics of an ATV carrying a load.

An additional object is to provide an ATV load support system that extends the useful life of an ATV rear suspension.

A further object is to provide an ATV load support system that allows an ATV operator to safely transport a heavy load without significantly affecting the handling characteristics of the ATV.

Another object is to provide an ATV load support system that may be adjusted to accommodate various weights of loads.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side view of the present invention attached to an ATV.

FIG. 2 is a side view of the present invention with a load positioned upon and attached to the ATV.

FIG. 3 is a side view of the present invention in a compressed position.

FIG. 4 is a side view of the present invention in an extended position.

FIG. 5 is a side view of the present invention.

FIG. 6 is a rear view of the present invention.

FIG. 7 is a top view of the present invention attached to the rear rack of the ATV.

### DESCRIPTION OF THE PREFERRED EMBODIMENT

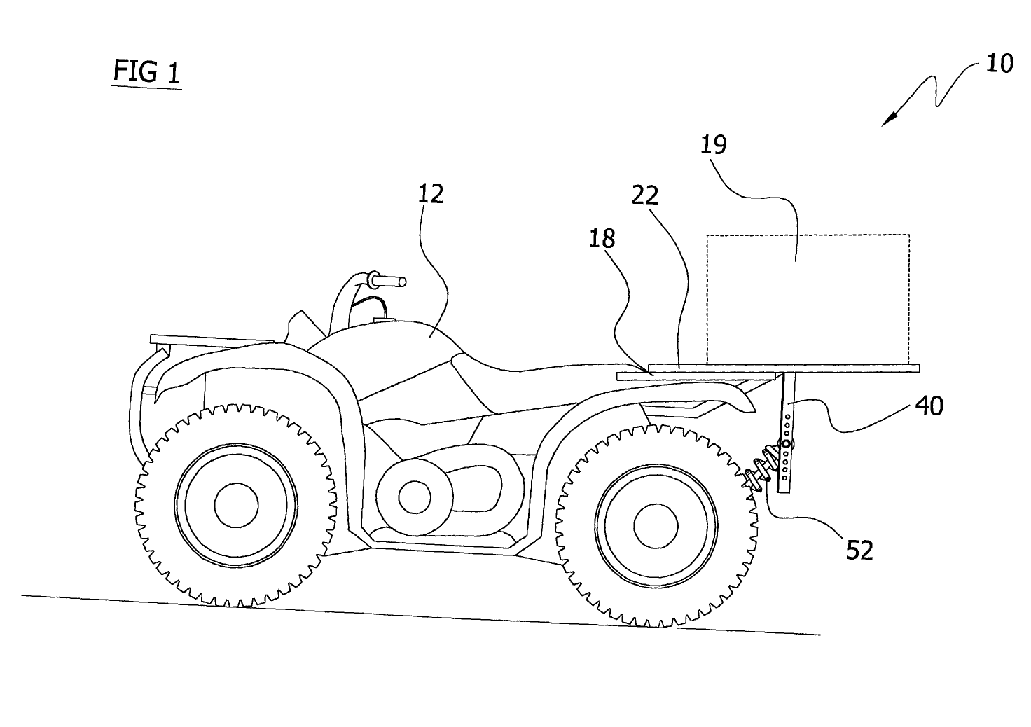

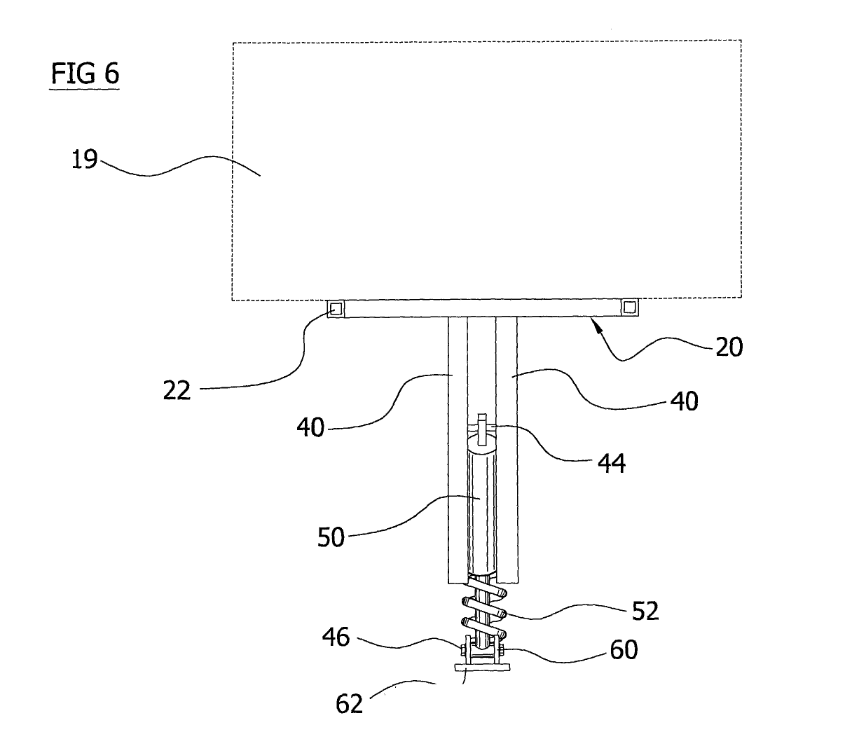

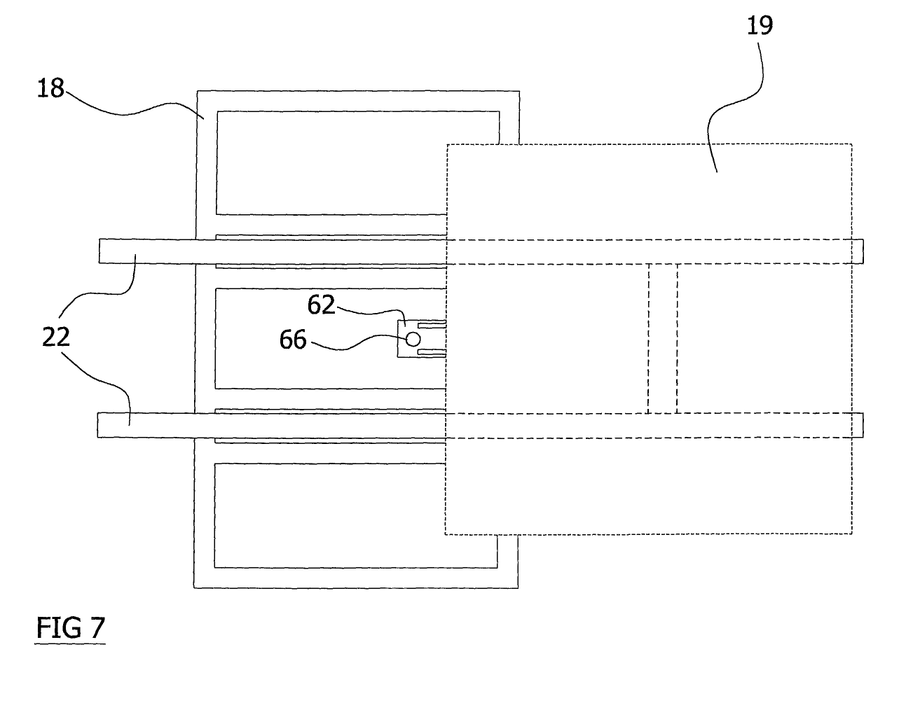

Turning now descriptively to the drawings, in which similar reference characters denote similar elements throughout the several views, FIGS. 1 through 7 illustrate an ATV load support system 10, which comprises an elongate support member 30 pivotally attached to a frame of the ATV 12 extending rearwardly, an upper frame 20 attached to the elongate support member 30 for receiving a load 19, a vertical member 40 attached to the upper frame 20 extending downwardly, an attachment member 62 having an upper bracket 60 attached to a rear hitch 14 of an ATV 12, and a first shock absorber 50 and compression spring 52 attached between the upper bracket 60 and the vertical member 40. The weight of the load 19 is transferred from the rear suspension 16 of the ATV 12 directly to the rear axle 17 of the ATV 12 thereby reducing wear upon the rear suspension 16.

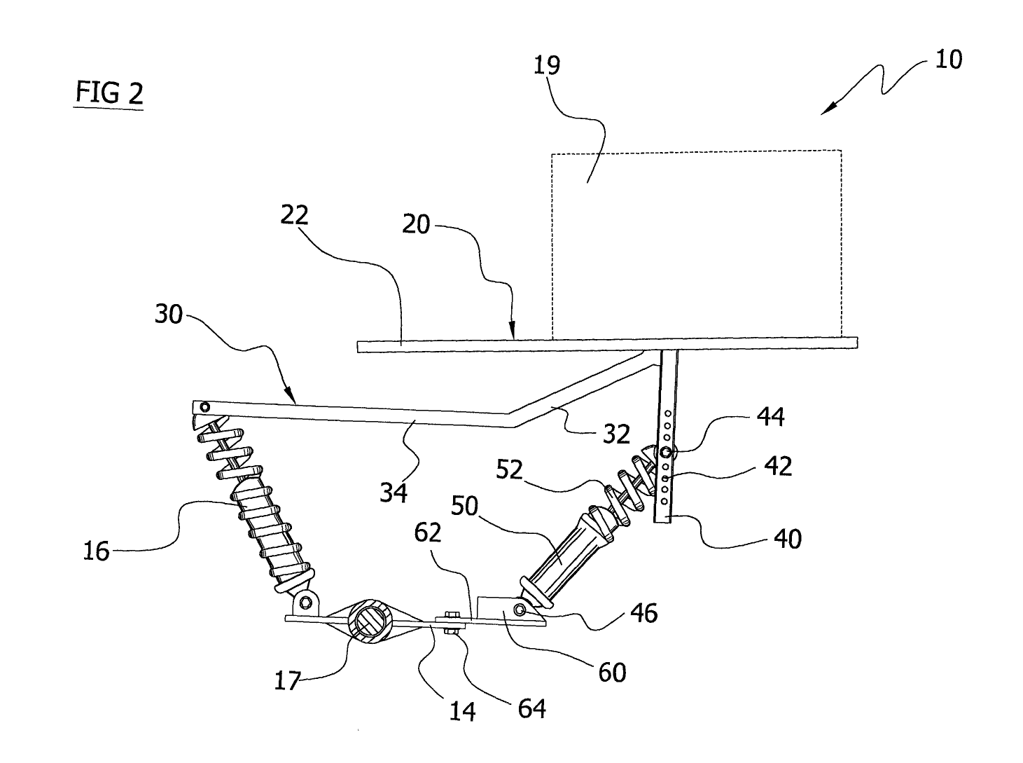

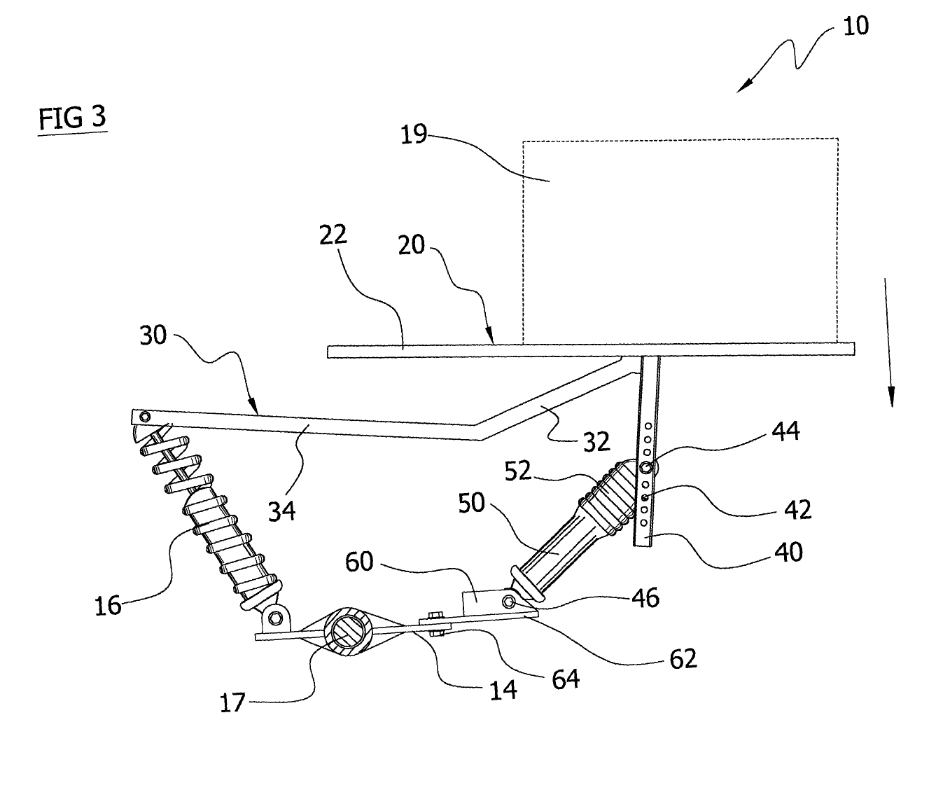

As shown in FIGS. 2 through 4 of the drawings, an elongate support member 30 is pivotally attached at one end to the frame of the ATV 12. FIGS. 2 through 3 illustrate the pivotal attachment of the elongate support member 30 to the upper connection of the rear suspension 16, however various other locations upon the ATV 12 may be utilized to attach the elongate support member 30. The elongate support member 30 may be pivotally or non-movably attached to the ATV 12.

As further shown in FIGS. 2 through 4 of the drawings, the elongate support member 30 includes a first segment 32 and a second segment 34 positioned at an angle with one another. The second segment 34 is attached to the ATV 12 and extends substantially horizontal from the rear portion of the ATV 12. The first segment 32 extends from the second segment 34 rearwardly and upwardly as best illustrated in FIGS. 2 through 4 of the drawings. The first segment 32 is attached to the upper frame 20 as shown in FIGS. 1 through 4 of the drawings.

The upper frame 20 may be comprised of various frame structures. The upper frame 20 may be comprised of various shapes and sizes designed to receive and secure the load 19. The upper frame 20 is attached to the first segment 32 as shown in FIGS. 2 through 4 of the drawings. At least one extended member 22 extends forwardly from the upper frame 20 to be secured to the rear rack 18 of the ATV 12 by conventional fasteners such as U-bolts or the like.

A vertical member 40 is attached to either the upper frame 20 or the elongate support member 30. The vertical member 40 extends downwardly as best illustrated in FIGS. 2 through 5 of the drawings. The vertical member 40 preferably includes a plurality of adjustment apertures 42 for adjustably receiving an upper fastener 44 for securing the first shock absorber 50.

As shown in FIGS. 2 through 6 of the drawings, a first shock absorber 50 is attached to the vertical member 40 in a desired location. The first shock absorber 50 preferably includes a compression spring 52 for movably supporting the weight of the load 19. The first shock absorber 50 may be comprised of any mechanical dampener for absorbing shocks such as hydraulic and pneumatic devices. The first shock absorber 50 may be comprised of a structure that applies an extension force that does not require the usage of a compression spring 52 which are well known for mechanical dampeners.

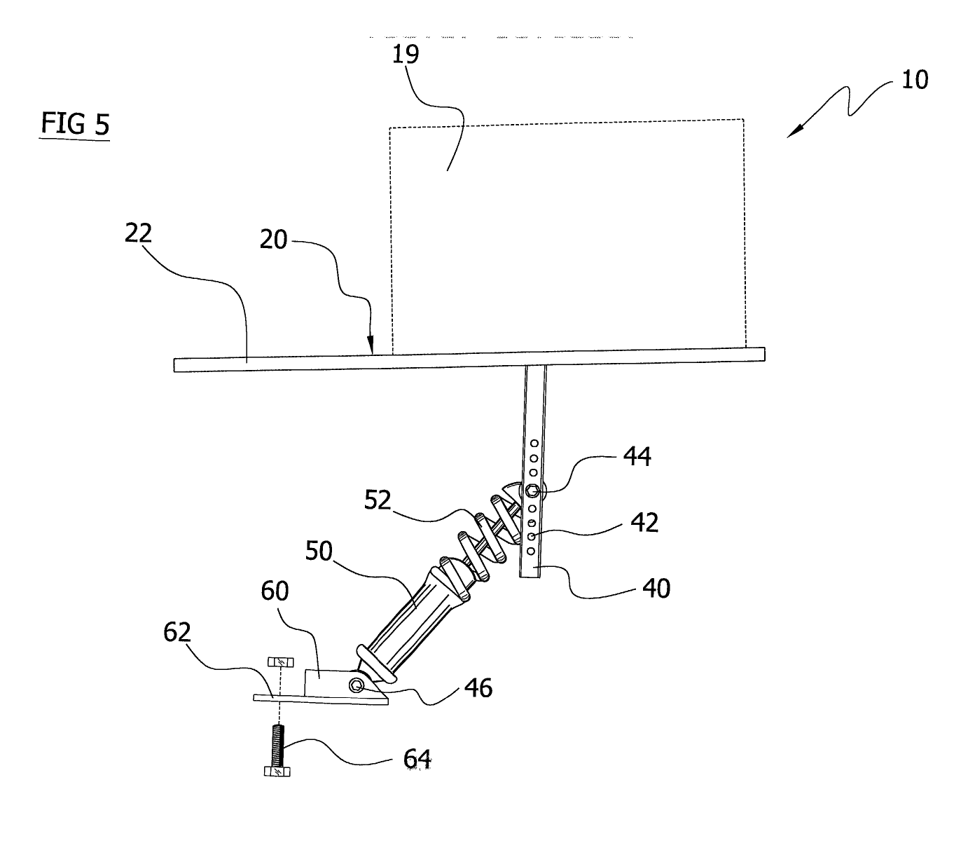

As best shown in FIG. 5 of the drawings, an attachment member 62 includes a receiving aperture 66 for receiving a securing fastener 64. The securing fastener 64 extends through the receiving aperture 66 within the attachment member 62 into the rear hitch 14 of the ATV 12 to secure the attachment member 62 directly and non-movably to the rear hitch 14 of the ATV 12. The attachment member 62 preferably is comprised of a straight and flat structure, however various other structures may be utilized to construct the attachment member 62.

An upper bracket 60 is preferably attached to the attachment member 62 for securing the lower end of the first shock absorber 50 with a lower fastener 46. The upper bracket 60 is preferably comprised of a pair of parallel members, however, various other structures may be utilized to construct the upper bracket 60.

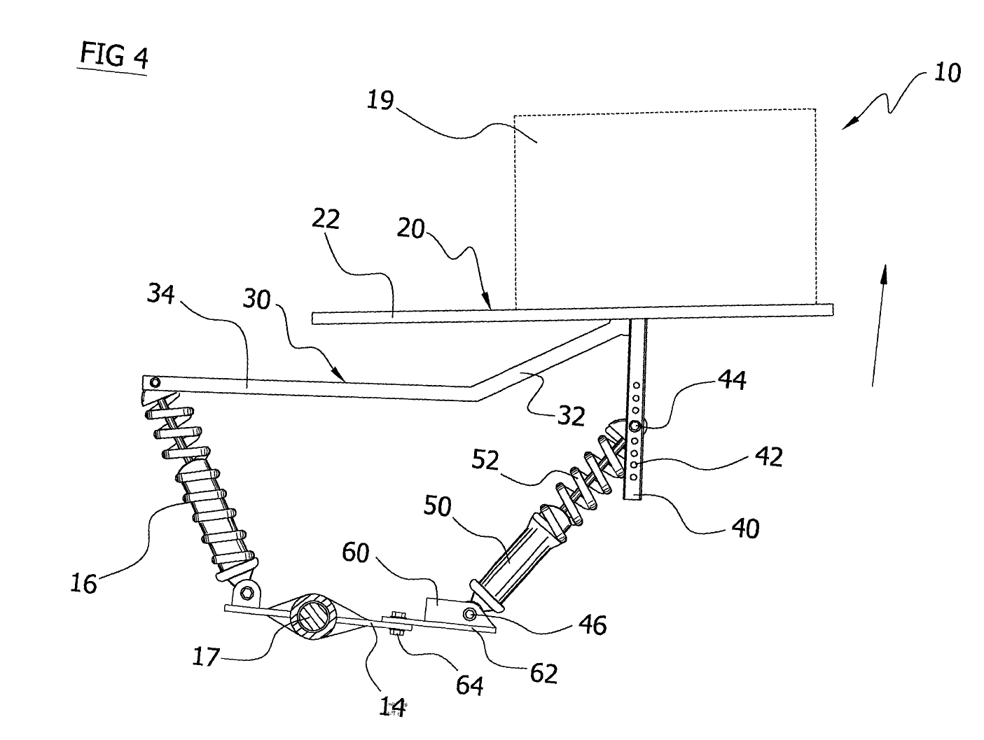

In use, the user secures the elongate support member 30 to the frame of the ATV 12. The user then secures the extended member 22 of the upper frame 20 to the rear rack 18 of the ATV 12. The user then secures the attachment member 62 to the hitch 14 of the ATV 12 using the securing fastener 64 or similar fastener. The user then attaches the first shock absorber 50 to the upper bracket 60 and then within the desired adjustment aperture 42 of the vertical member 40. If the load 19 is heavier, the user will attach the first shock absorber 50 to a lower adjustment aperture 42 to accommodate for the increased weight. If the load 19 is lighter, the user will attach the first shock absorber 50 to a higher adjustment aperture 42. The user then positions the load 19 upon the upper frame 20 as shown in FIG. 2 of the drawings. The load may be comprised of one or more weight members, a chemical applicator, a fluid reservoir, generator or other item. When the ATV 12 encounters a bump, depression or similar obstruction, as the rear wheels of the ATV 12 are elevated the load 19 is allowed to maintain a relatively stationary position with the weight transferred to the rear axle 17 instead of through the rear suspension 16 as shown in FIG. 3 of the drawings. The compression spring 52 then elevates the upper frame 20 with the load 19 upwardly until the normal position is reached as shown in FIG. 4 of the drawings. When the present invention is no longer required, the above-stated installation process is simply reversed.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An ATV load support system, comprising:
an attachment member attachable to a rear hitch of an ATV;
an upper frame securable to a rear portion of said ATV, wherein said upper frame is capable of receiving a load; and
a mechanical dampener attached between said attachment member and said upper frame for supporting said upper frame and said load.

2. The ATV load support system of claim 1, wherein said attachment member includes a receiving aperture for receiving a securing fastener.

3. The ATV load support system of claim 1, wherein said upper frame includes at least one extended member securable to a rear rack of said ATV.

4. The ATV load support system of claim 1, wherein said mechanical dampener includes a compression spring.

5. The ATV load support system of claim 1, including an elongate support member attached to said upper frame and extending forwardly with a distal portion attachable to a frame of said ATV.

6. The ATV load support system of claim 5, wherein said elongate support member is comprised of a first segment and a second segment, wherein said segments are positioned at an angle with respect to one another.

7. The ATV load support system of claim 6, wherein first segment extends upwardly from said second segment to attach to said upper frame.

8. The ATV load support system of claim 1, wherein said attachment member includes an upper bracket that receives a lower end of said mechanical dampener.

9. The ATV load support system of claim 1, wherein said attachment member is comprised of an elongate structure.

10. The ATV load support system of claim 9, wherein said attachment member is comprised of a flat structure.

11. An ATV load support system, comprising:
an attachment member attachable to a rear hitch of an ATV;
an upper frame securable to a rear portion of said ATV, wherein said upper frame is capable of receiving a load;
a vertical member extending downwardly from said upper frame; and
a mechanical dampener attached between said attachment member and said upper frame for supporting said upper frame and said load.

12. The ATV load support system of claim 11, wherein said attachment member includes a receiving aperture for receiving a securing fastener.

13. The ATV load support system of claim 11, wherein said upper frame includes at least one extended member securable to a rear rack of said ATV.

14. The ATV load support system of claim 11, wherein said mechanical dampener includes a compression spring.

15. The ATV load support system of claim 11, including an elongate support member attached to said upper frame and extending forwardly with a distal portion attachable to a frame of said ATV.

16. The ATV load support system of claim 15, wherein said elongate support member is comprised of a first segment and a second segment, wherein said segments are positioned at an angle with respect to one another.

17. The ATV load support system of claim 16, wherein first segment extends upwardly from said second segment to attach to said upper frame.

18. The ATV load support system of claim 11, wherein said attachment member includes an upper bracket that receives a lower end of said mechanical dampener.

19. The ATV load support system of claim 11, wherein said attachment member is comprised of an elongate structure.

20. The ATV load support system of claim 11, wherein said vertical member includes a plurality of adjustment apertures for receiving an upper fastener for adjustably securing said mechanical dampener to said vertical member.
